(19) United States
(12) Patent Application Publication
(10) Pub. No.: US 2025/0350060 A1
(43) Pub. Date: Nov. 13, 2025

(54) ELECTRICAL CONNECTOR HAVING TERMINAL POSITION ASSURANCE DEVICE

(71) Applicant: TE Connectivity Solutions GmbH, Schaffhausen (CH)

(72) Inventors: Kevin John Peterson, Kernersville, NC (US); Matthew Bryan Hitchcock, Hershey, PA (US); Ram Kishore Venkatesan, Winston Salem, NC (US)

(21) Appl. No.: 18/731,493

(22) Filed: Jun. 3, 2024

Related U.S. Application Data
(60) Provisional application No. 63/645,180, filed on May 10, 2024.

(51) Int. Cl. H01R 13/405; H01R 13/50; H01R 13/627; H01R 13/64

(52) U.S. Cl. CPC H01R 13/405; H01R 13/501; H01R 13/6273; H01R 13/64

(57) ABSTRACT

An electrical connector includes a housing having a terminal cavity between a front and a rear. The housing has an access window open to the terminal cavity and device walls forming a device channel aligned with the access window. The electrical connector includes a terminal in the terminal cavity having a mating end and a terminating end. The electrical connector includes a TPA device received in the device channel configured to move between an open position and a closed position. The TPA device includes an interference element configured to interface with a positioning element of the terminal in the closed position to assure proper positioning of the terminal in the terminal channel. The TPA device includes sacrificial connecting tabs holding the TPA device at the open position configured to be separated to release the TPA device and allow movement of the TPA device from the open position to the closed position.

### CROSS REFERENCE TO RELATED APPLICATIONS

This application claims benefit to U.S. Application No. 63/645,180, filed 10 May 2024, titled “ELECTRICAL CONNECTOR HAVING TERMINAL POSITION ASSURANCE DEVICE” the subject matter of which is herein incorporated by reference in its entirety.

### BACKGROUND OF THE INVENTION

The subject matter herein relates generally to electrical connectors.

Electrical connectors are used to electrically connect various components. The electrical connectors may be used to transfer data and/or power between various components. Typically, the electrical connector includes a housing that holds one or more contacts are terminals. There is a need to assure that the contacts are terminals are properly positioned within the housing for proper mating with the mating electrical connector. Some known electrical connectors use a terminal position assurance device to assure proper positioning of the terminals. Typically, the terminal position assurance device is a separate component, which is separately manufactured from the housing, and which is configured to be coupled to the housing in a particular position or orientation after the terminals are loaded into the housing. Separately manufacturing the components and assembly of the components adds cost and complexity to the manufacturing and assembly processes. Some known electrical connectors connect the terminal position assurance device to the housing using a hinge, which may be formed integral with the terminal position assurance device in the housing. However, the hinge is susceptible to damage or breakage over time. For example, the hinge may become brittle over time. The components may be manufactured from a plastic material that is ductile or pliable to reduce risk of breakage of the hinge. However, such materials may not be suitable for all applications, such as high temperature applications.

A need remains for an electrical connector having a terminal position assurance device that may be manufactured in a cost effective and reliable manner.

### BRIEF DESCRIPTION OF THE INVENTION

In one embodiment, an electrical connector is provided and includes a housing extending between a front and a rear. The housing has a terminal cavity between the front and the rear. The housing has an access window open to the terminal cavity. The housing has device walls forming a device channel aligned with the access window. The electrical connector includes a terminal received in the terminal cavity. The terminal includes a mating end configured to be mated with a mating terminal. The terminal has a terminating end configured to be terminated to a cable. The terminal includes a positioning element. The electrical connector includes a terminal position assurance (TPA) device received in the device channel. The TPA device is configured to move between an open position and a closed position. The TPA device includes an interference element configured to interface with the positioning element of the terminal in the closed position to assure proper positioning of the terminal in the terminal channel. The TPA device includes sacrificial connecting tabs holding the TPA device at the open position. The sacrificial connecting tabs are configured to be separated to release the TPA device and allow movement of the TPA device from the open position to the closed position.

In a further embodiment, an electrical connector is provided and includes a housing extending between a front and a rear. The housing has a terminal cavity between the front and the rear. The housing has an access window open to the terminal cavity. The housing has device walls forming a device channel aligned with the access window. The housing includes a front latching element in the device channel and a rear latching element in the device channel. The electrical connector includes a terminal received in the terminal cavity. The terminal includes a mating end configured to be mated with a mating terminal. The terminal has a terminating end configured to be terminated to a cable. The terminal includes a positioning element. The electrical connector includes a terminal position assurance (TPA) device received in the device channel. The TPA device is configured to move between an open position and a closed position. The TPA device includes a main panel, a front wall extending from a front of the main panel, and a rear wall extending from a rear of the main panel. The front wall includes a front latch. The rear wall includes a rear latch. The TPA device includes an interference element configured to interface with the positioning element of the terminal in the closed position to assure proper positioning of the terminal in the terminal channel. The TPA device includes front sacrificial connecting tabs extending from the front wall. The TPA device includes rear sacrificial connecting tabs extending from the rear wall. The front and rear sacrificial connecting tabs configured to connect to the device walls of the housing hold the TPA device at the open position. The front and rear sacrificial connecting tabs are configured to be separated from the device walls to release the TPA device and allow movement of the TPA device from the open position to the closed position.

In a further embodiment, an electrical connector is provided and includes a housing extending between a front and a rear. The housing includes a molded housing body being manufactured from a plastic material. The housing has a terminal cavity between the front and the rear. The housing has an access window open to the terminal cavity. The housing has device walls forming a device channel aligned with the access window. The electrical connector includes a terminal received in the terminal cavity. The terminal includes a mating end configured to be mated with a mating terminal. The terminal has a terminating end configured to be terminated to a cable. The terminal includes a positioning element. The electrical connector includes a terminal position assurance (TPA) device includes a molded device body manufactured from the plastic material of the housing. The TPA device received in the device channel. The TPA device is configured to move between an open position and a closed position. The TPA device includes an interference element configured to interface with the positioning element of the terminal in the closed position to assure proper positioning of the terminal in the terminal channel. The TPA device includes sacrificial connecting tabs holding the TPA device at the open position. The sacrificial connecting tabs includes molded sacrificial bodies being manufactured from the plastic material of the housing. The sacrificial connecting tabs are configured to be separated to release the TPA device and allow movement of the TPA device from the open position to the closed position. The molded housing body, the molded device body, and the molded sacrificial bodies are a monolithic unitary structure prior to breaking of the sacrificial connecting tabs.

### BRIEF DESCRIPTION OF THE DRAWINGS

FIG. 1 illustrates an electrical connector in accordance with an exemplary embodiment.

FIG. 2 illustrates an enlarged view of a portion of the electrical connector in accordance with an exemplary embodiment.

FIG. 3 illustrates the terminal in accordance with an exemplary embodiment.

FIG. 4 is a sectional view of a portion of the electrical connector showing the TPA device in the open position in accordance with an exemplary embodiment.

FIG. 5 is a sectional view of a portion of the electrical connector showing the TPA device in the closed position in accordance with an exemplary embodiment.

### DETAILED DESCRIPTION OF THE INVENTION

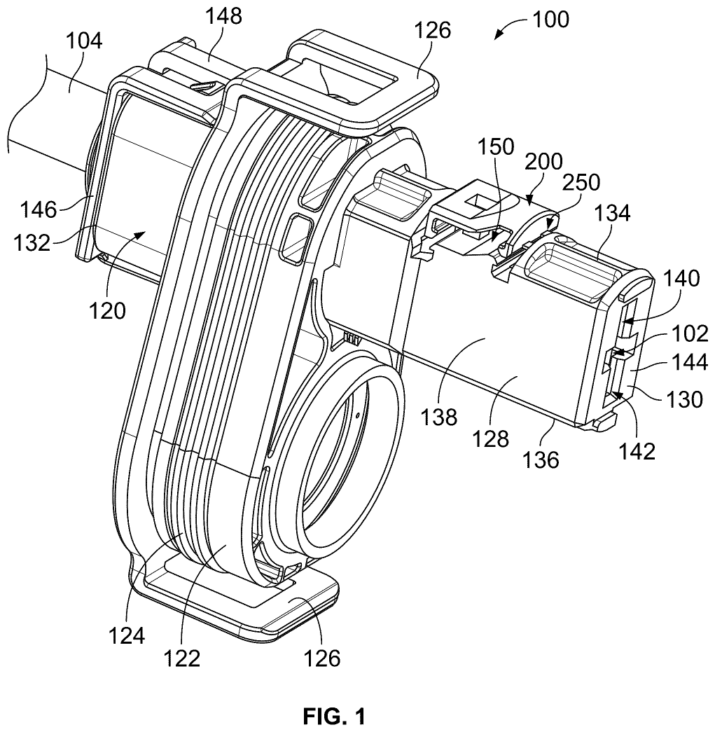

FIG. 1 illustrates an electrical connector 100 in accordance with an exemplary embodiment. The electrical connector 100 includes a terminal 102 coupled to an end of a cable 104 and configured to be mated to a mating terminal of a mating electrical connector (not shown). In an exemplary embodiment, the electrical connector 100 is a power connector and the terminal 102 is a power terminal and the cable 104 is a power cable. The electrical connector 100 may include multiple terminals 102 in other various embodiments. The electrical connector 100 may be used in an automotive application, such as an electric vehicle. The electrical connector 100 may be used in other types of vehicles or machines. The electrical connector 100 may be used in other applications, such as appliances, industrial applications, computer systems, military, aerospace, medical applications, and the like.

The electrical connector 100 includes a housing 120. The housing 120 holds the terminal 102. The cable 104 may extend from the housing 120. In an exemplary embodiment, the housing 120 includes a mounting flange 122 configured be mounted to a mounting structure, such as a device, chassis, panel, or other component. For example, the housing 120 may pass through an opening in the mounting structure. In an exemplary embodiment, a seal 124 is provided at the mounting flange 122 configured to seal between the housing 120 and the mounting structure. In an exemplary embodiment, the housing 120 includes locking elements 126 used to secure the electrical connector 100 to the mounting structure.

In an exemplary embodiment, the housing 120 is manufactured from a dielectric material, such as a plastic material. In various embodiments, the housing 120 is manufactured from a high temperature plastic material to withstand high temperature applications. For example, the housing 120 may be manufactured from a polyether ether ketone (PEEK) material or a polyether ketone (PEK). The housing 120 may be a molded part, such as an injection molded part. For example, the housing 120 includes a molded housing body 128 molded from a dielectric material, such as a plastic material. In various embodiments, the molded housing body 128 is formed by a single injection molding process. In an exemplary embodiment, other components are co-molded with the housing 120 during the single injection molding process to reduce molding processes, reduce the number of separate parts, and reduce the cost of the overall system. For example, a terminal position assurance (TPA) device 200 is co-molded with the housing 120 during a common injection molding process. In an exemplary embodiment, the TPA device 200 is molded with sacrificial connecting tabs therebetween, which are configured to be broken during assembly to separate the TPA device 200 from the housing 120. For example, the sacrificial connecting tabs are molded between the TPA device 200 and the housing 120 during the single injection molding process. Such manufacturing process simplifies manufacturing and assembly of the electrical connector 100 and reduces the overall cost of production of the electrical connector 100.

The housing 120 extends between a front 130 and a rear 132. The front 130 defines a mating end of the electrical connector 100 configured to be mated with the mating electrical connector. In the illustrated embodiment, the cable 104 extends from the rear 132. However, the cable 104 may extend from other portions of the housing 120 in alternative embodiments. The mounting flange 122 may be located between the front 130 and the rear 132, such as approximately centered between the front 130 and the rear 132. In an exemplary embodiment, the housing 120 extends between a top 134 and a bottom 136. The housing 120 includes sides 138 between the top 134 and the bottom 136. In the illustrated embodiment, the locking element 126 are provided at the top 134 and the bottom 136. Other locations are possible in alternative embodiments, such as along the sides 138.

The housing 120 includes a terminal cavity 140 that receives the terminal 102. The terminal cavity 140 is sized and shaped to receive the terminal 102. The terminal cavity 140 may be sized, such as at the rear 132, to receive the cable 104. The housing 120 includes housing walls that surround the terminal cavity 140. In various embodiments, the housing walls may have a shape that approximates the shape of the terminal 102, providing an enclosure that surrounds the terminal 102. The housing 120 includes features that support them position the terminal 102 in the terminal cavity 140.

In an exemplary embodiment, the housing 120 includes a mating opening 142 at the front 130 that provides access to the terminal cavity 140. The mating contact may be plugged into the terminal cavity 140 through the mating opening 142 to mate with the terminal 102. In the illustrated embodiment, the mating opening 142 is an elongated slot. The slot may be elongated in a horizontal direction, such as between the top 134 and the bottom 136. The mating opening 142 may have other shapes in alternative embodiments.

In an exemplary embodiment, the housing 120 includes a front wall 144 at the front 130. The mating opening 142 passes through the front wall 144. The front wall 144 covers a portion of the terminal 102. The front wall 144 may retain the terminal 102 in the terminal cavity 140. For example, the terminal 102 may be loaded into the terminal cavity 140 through the rear 132 to abut against the interior side of the front wall 144.

In an exemplary embodiment, the housing 120 includes a cable cover 146 coupled to the housing 120 at the rear 132. The cable cover 146 covers the cable 104. The cable 104 may exit the housing 120 through the cable cover 146. The cable cover 146 may provide strain relief for the cable 104. In an exemplary embodiment, the cable cover 146 includes a latch 148 configured to be latchably coupled to the housing 120. Other types of securing features may be used in alternative embodiments in various embodiments, the cable cover 146 may hold a cable seal (not shown) configured to be sealed to the outer jacket of the cable 104.

With additional reference to FIG. 2, which is an enlarged view of a portion of the electrical connector 100, in an exemplary embodiment, the housing 120 includes a device channel 150 that receives the TPA device 200. The device channel 150 is formed by device walls 152, such as a front device wall 154 and a rear device wall 156. In the illustrated embodiment, the device channel 150 is located at the top 134 of the housing 120. Other locations are possible in alternative embodiments, such as the bottom 136 or the sides 138. The device channel 150 forms a pocket that receives the TPA device 200 to allow the TPA device 200 to nest into the housing 120. For example, when applied, the TPA device 200 may sit flush or be recessed below the top 134 of the housing 120. In an exemplary embodiment, the housing 120 includes a locating tab 158 extending into the device channel 150. The locating tab 158 is used to locate the TPA device 200 in the device channel 150. For example, the locating tab 158 may control a side to side and/or a front to rear position of the TPA device 200 in the device channel 150. In the illustrated embodiment, the locating tab 158 is a rectangular post. The locating tab 158 may have other shapes in alternative embodiments.

In an exemplary embodiment, the housing 120 includes latching elements used to secure the TPA device 200 to the housing 120. For example, the housing 120 includes a front latching element 160 and a rear latching element 162. The front latching element 160 is located proximate to the front device wall 154. The rear latching element 162 is located proximate to the rear device wall 156 are routed in an exemplary embodiment, the TPA device 200 is configured be positioned between the latching elements 160, 162 and the corresponding device walls 154, 156. Each latching element 160 includes a latching surface 164. For example, the latching element 162 includes a flange or protrusion forming the latching surface 164. In the illustrated embodiment, the latching surface 164 is downward facing to hold the TPA device 200 in a latched position and prevent lift off or removal of the TPA device 200 after the TPA device 200 is actuated and latched to the housing 120. Other types of securing features may be used in alternative embodiments.

In an exemplary embodiment, the housing 120 includes an access window 170 open to the terminal cavity 140. The TPA device 200 is configured to pass through the access window 170 into the terminal cavity 140 To interface with the terminal 102 to operate as a locking feature to lock the terminal 102 in the terminal cavity 140. In the illustrated embodiment, the access window 170 is located in the device channel 150. For example, the access window 170 is located at the bottom of the device channel 150. The access window 170 is provided in the upper wall of the housing 120 at the top 134. In the illustrated embodiment, the access window 170 is located proximate to the rear device wall 156, such as immediately forward of the rear device wall 156. Other locations are possible in alternative embodiments.

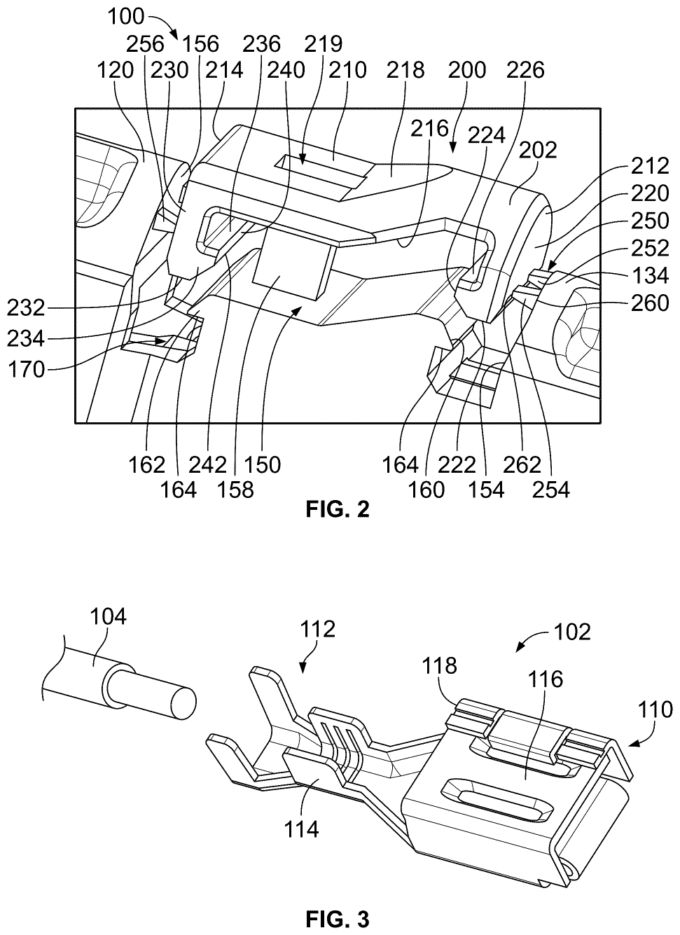

The TPA device 200 is used to provide position assurance of the terminal 102 in the terminal cavity 140. For example, the TPA device 200 is utilized to assure that the terminal 102 is fully loaded into the terminal cavity 140. The TPA device 200 provides a visual and/or tactical evidence to the installer that the terminal 102 is fully loaded into the terminal cavity 140. For example, during assembly, TPA device 200 is actuated to move from an un-actuated or open position (shown in FIGS. 2 and 3) to an actuated or closed position (shown in FIG. 5). The TPA device 200 is only capable of moving from the open position to the closed position when the terminal 102 is fully loaded into the terminal cavity 140. If the terminal 102 is only partially loaded into the terminal cavity 140, the TPA device 200 is unable to move to the closed position providing evidence to the installer that the terminal 102 is improperly loaded. In the closed position, the TPA device 200 interfaces with the terminal 102 to provide locking of the terminal 102 in the terminal cavity 140. For example, the TPA device 200 blocks removal of the terminal 102 from the terminal cavity 140.

In an exemplary embodiment, the TPA device 200 is formed with the housing 120 during a common molding process. For example, the TPA device 200 is co-molded with the housing 120. The TPA device 200 is made from the same plastic material as the housing 120. When initially molded, the TPA device 200 is integral with the housing 120 and fixed at a pre-position aligned with the device channel 150 and the access window 170. The TPA device 200 is simply pressed inward and an actuating direction to move the TPA device 200 to the closed position. The actuation process separates the TPA device 200 from the housing 120 by breaking the sacrificial breakaway tabs that are molded between the TPA device 200 and the housing 120.

In an exemplary embodiment, the TPA device 200 includes a main panel 210, a front wall 220 extending from a front 212 of the main panel 210, and a rear wall 230 extending from a rear 214 of the main panel 210. The front wall 220 and/or the rear wall 230 may extend perpendicular to the main panel 210. For example, the main panel 210 may be oriented generally horizontally and the front and rear walls 220, 230 may be oriented generally vertically. The front wall 220 and/or the rear wall 230 may extend downward from the bottom of the main panel 210. In various embodiments, the main panel 210 is planar. However, in alternative embodiments, the main panel 210 be nonplanar, such as being stepped upward or downward at the front 212 or the rear 214. For example, in the illustrated embodiment, the main panel 210 is stepped upward at the front 212 such that the front wall 220 is elevated relative to the rear wall 230. The TPA device 200 may have other shapes in alternative embodiments.

The main panel 210 includes an inner surface 216 and an outer surface 218. The inner surface 216 faces the housing 120. For example, the inner surface 216 faces the bottom of the device channel 150. The outer surface 218 faces outward. The installer is able to press against the outer surface 218 to actuate the TPA device 200 and move the TPA device 200 from the open position to the closed position. For example, the TPA device 200 may include a press surface or pusher or button configured to be pressed or actuated by the installer. When the TPA device 200 is actuated and moved inward toward the housing 120, the main panel 210 may be recessed into the device channel 150 may be seated flush with the exterior of the housing 120.

In an exemplary embodiment, the main panel 210 includes a locating opening 219. The locating opening 219 is aligned with the locating tab 158. When the TPA device 200 is actuated to the closed position, the locating tab 158 is received in the locating opening 219. The locating tab 158 locates the TPA device 200 relative to the housing 120. For example, the locating tab 158 may control side to side and/or front to rear positioning of the TPA device 200 relative to the housing 120. Other types of locating features may be used in alternative embodiments.

The front wall 220 extends to a distal end 222. In an exemplary embodiment, the front wall 220 includes a front latch 224 configured to be latchably secured to the housing 120. For example, the front latch 224 may interface with the front latching element 160. The front latch 224 may be deflectable to interface with the front latching element 160. The front latch 224 includes a latching surface 226. The latching surface 226 is configured to interface with the latching surface 164. For example, the latching surface 226 may be upward facing and the latching surface 164 may be downward facing. The front latch 224 may be captured below the latching surface 164 of the front latching element 160 to latchably secure the front wall 220 to the housing 120. Other types of latching features may be used in alternative embodiments.

The rear wall 230 extends to a distal end 232. In an exemplary embodiment, the rear wall 230 includes a rear latch 234 configured to be latchably secured to the housing 120. For example, the rear latch 234 may interface with the rear latching element 162. The rear latch 234 may be deflectable to interface with the rear latching element 162. The rear latch 234 includes a latching surface 236. The latching surface 236 is configured to interface with the latching surface 164. For example, the latching surface 236 may be upward facing and the latching surface 164 may be downward facing. The rear latch 234 may be captured below the latching surface 164 of the rear latching element 162 to latchably secure the rear wall 230 to the housing 120. Other types of latching features may be used in alternative embodiments.

In an exemplary embodiment, the TPA device 200 includes an interference element 240 configured to interface with the terminal 102 in the closed position to assure proper positioning of the terminal 102 in the terminal channel 140. The interference element 240 is configured to be received in the access window 170 when the TPA device 200 is actuated to the closed position. In an exemplary embodiment, the interference element 240 is provided on the rear wall 230. For example, the interference element 240 is defined by a front surface 242 of the rear wall 230. The front surface 242 is configured to face a rear facing surface of the terminal 102 to block pullout of the terminal 102 in the terminal channel 140. Other types of interference elements may be used in alternative embodiments. The interference element 240 may be provided on an alternative portion of the TPA device 200, such as separate from the rear wall 230. For example, the TPA device 200 may include a separate protrusion or tab extending from the main panel 210 configured be received in the access window 170 to interface with the terminal 102.

In an exemplary embodiment, the TPA device 200 includes sacrificial connecting tabs 250 extending between the TPA device 200 and the housing 120. For example, the TPA device 200 includes front sacrificial connecting tabs 254 between the front wall 220 and the front device wall 154 and rear sacrificial connecting tabs 256 between the rear wall 230 and the rear device wall 156. Optionally, multiple front sacrificial connecting tabs 254 and/or multiple rear sacrificial connecting tabs 256 may be provided. The sacrificial connecting tabs 250 are used to hold the TPA device 200 at the open position. For example, the sacrificial connecting tabs 250 suspend the TPA device 200 above the housing 120 aligned with the device channel 150. The sacrificial connecting tabs 250 are configured to be separated or break to release the TPA device 200 and allow movement of the TPA device from the open position to the closed position. The sacrificial connecting tabs 254 are breakaway tabs configured to purposely break and allow separation of the TPA device 200 from the housing 120.

The sacrificial connecting tabs 250 are co-molded with the TPA device 200 and the housing 120. For example, the sacrificial connecting tabs 250 include molded sacrificial bodies 252 that are manufactured from the plastic material of the housing 120. The molded sacrificial bodies 252 are co-molded with the molded housing body 128. The molded sacrificial bodies 252 are integral with the molded housing body 128. Similarly, the TPA device 200 includes a molded device body 202 that is manufactured from the plastic material of the housing 120. The molded device body 202 is co-molded with the molded housing body 128 and the molded sacrificial bodies 252. The molded device body 202 is integral with the molded housing body 128 and the molded sacrificial bodies 252. In an exemplary embodiment, during the molding process, the plastic material forming the molded device body 202 is injected into that portion of the mold through openings in the mold that form the molded sacrificial bodies 252. As such, the plastic material forming the TPA device 200 is filled through the sacrificial connecting tabs 250. In an exemplary embodiment, the sacrificial connecting tabs 250, the TPA device 200, and the housing 120 are integrated as a monolithic unitary structure. The sacrificial connecting tabs 250, the TPA device 200, and the housing 120 are manufactured from a common plastic material, which is molded during a single molding process to reduce molding processes, reduce the number of separate parts, and reduce the cost of the overall system. Such manufacturing process simplifies manufacturing and assembly of the electrical connector 100 and reduces the overall cost of production of the electrical connector 100.

In the illustrated embodiment, the sacrificial connecting tabs 250 are wedge shaped. For example, each sacrificial connecting tab 250 includes a wide portion or base 260 and a narrow portion or neck 262. In the illustrated embodiment, the base 260 is provided at the housing 120 and the neck 262 is provided at the TPA device 200. However, in alternative embodiments, the neck 262 may be provided at the housing 120 and the base 260 provided at the TPA device 200. In other alternative embodiments, the sacrificial connecting tab 250 may include bases 260 at both the housing 120 and the TPA device 200 with the neck 262 centered between the bases 260 remote from both the TPA device 200 and the housing 120. The neck 262 forms a weekend area of the sacrificial connecting tab 250. The sacrificial connecting tab 250 is configured to break at the neck 262 when sufficient pressure is applied to the TPA device 200 to move the TPA device 200 to the closed position. The TPA device 200 is integral with fixed to the housing 120 in the open position, but is separated (not integral) from the housing 120 in the closed position. However, the latches are used to couple the TPA device 200 to the housing 120 in the closed position when the sacrificial connecting tabs 250 are broken and no longer connecting the TPA device 200 to the housing 120.

FIG. 3 illustrates the terminal 102 in accordance with an exemplary embodiment. The terminal 102 extends between a mating end 110 and a terminating end 112. The mating end 110 is configured to be mated with the mating terminal. The cable 104 is configured to be terminated to the terminal 102 at the terminating end 112. In the illustrated embodiment, the terminal 102 includes a crimp barrel 114 at the terminating end 112. The crimp barrel is configured to be crimped to the cable 104.

In an exemplary embodiment, the terminal 102 includes a socket 116 at the mating end. The socket 116 is configured to receive the mating terminal (not shown). For example, the mating terminal may be a blade terminal having a planar mating portion configured to be plugged into the socket 116. In alternative embodiments, the mating terminal may be a pin terminal, a spring terminal, or another type of terminal. In the illustrated embodiment, the socket 116 is box shaped having 4 walls forming the box shaped socket 116. The socket 116 may have other shapes in alternative embodiments. The terminal 102 may include spring beams are mating beams extending into the socket 116 to interface with the mating terminal.

In an exemplary embodiment, the terminal 102 includes a positioning element 118 for positioning the terminal 102 in the terminal cavity 140 (shown in FIG. 1). In an exemplary embodiment, the TPA device 200 (shown in FIG. 1) is configured to interface with the positioning element 118. For example, the interference element 240 of the TPA device 200 may interface with the positioning element 118. In the illustrated embodiment, the positioning element 118 is located at a rear edge of the socket 116. However, other locations are possible in alternative embodiments. The interference element 240 of the TPA device 200 is configured to be positioned rearward of the positioning element 118 to block pullout or removal of the terminal 102 from the terminal cavity 140. As such, the TPA device 200 forms a locking element configured to lock the terminal 102 in the terminal cavity 140. Other types of positioning element 118 may be provided in alternative embodiments. For example, the positioning element 118 may include an opening or pocket in 1 of the walls of the socket 116 configured to receive the interference element 240 inside the socket 116.

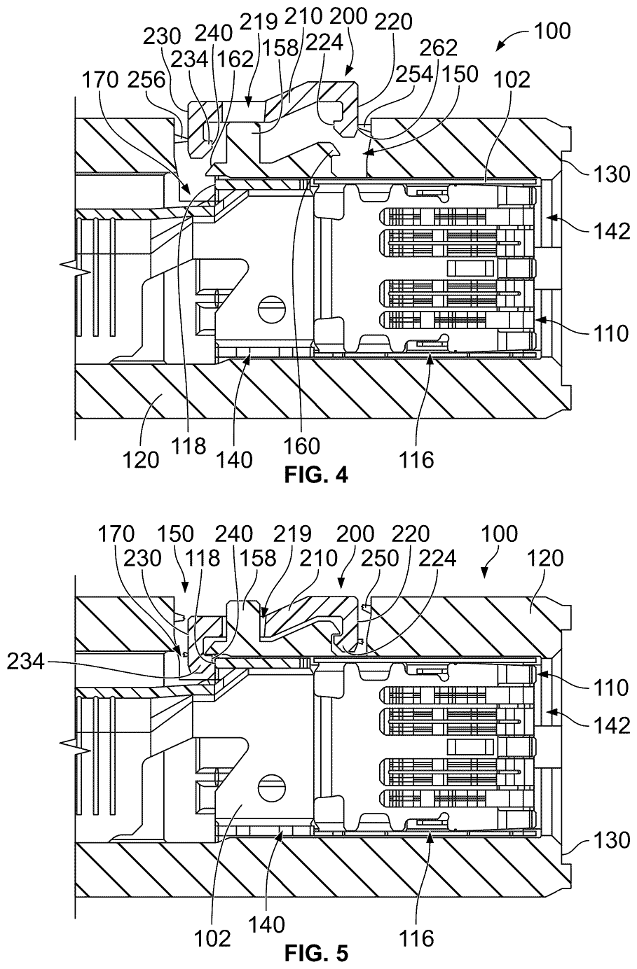

FIG. 4 is a sectional view of a portion of the electrical connector 100 showing the TPA device 200 in the open position. FIG. 5 is a sectional view of a portion of the electrical connector 100 showing the TPA device 200 in the closed position.

During manufacture, the TPA device 200 is co-molded with the housing 120. For example, the sacrificial connecting tabs 250 are co-molded with the TPA device 200 and the housing 120. The sacrificial connecting tabs 250, the TPA device 200, and the housing 120 are integrated as a monolithic unitary structure. The sacrificial connecting tabs 250, the TPA device 200, and the housing 120 are manufactured from a common plastic material, which is molded during a single molding process to reduce molding processes, reduce the number of separate parts, and reduce the cost of the overall system. Such manufacturing process simplifies manufacturing and assembly of the electrical connector 100 and reduces the overall cost of production of the electrical connector 100. The sacrificial connecting tabs 250 hold the TPA device 200 and the open position until the sacrificial connecting tabs 250 are broken, thus releasing the TPA device 200 to move to the closed position. In an exemplary embodiment, the front sacrificial connecting tabs 254 hold the front wall 220 and the rear sacrificial connecting tabs 256 hold the rear wall 230. Both ends of the TPA device 200 are supported by the corresponding sacrificial connecting tabs 254, 256. Both ends of the TPA device 200 are configured be released when the sacrificial connecting tabs 254, 256 are broken, thus completely separating the TPA device 200 from the housing 120 to allow movement of the TPA device 200 from the open position to the closed position. Both ends of the TPA device 200 are configured to be latchably secured to the housing 120 in the closed position independent of any flashing overmolding structure between the TPA device 200 and the housing 120. For example, the TPA device 200 does not include any living hinge or other flimsy or flexible element between the TPA device 200 in the housing 120. Rather, the TPA device 200 uses the robust latches 224, 234 at both ends of the TPA device 200 to secure the TPA device 200 to the housing 120. The plastic material used to mold the housing 120 and the TPA device 200 may be made from a plastic material that is suitable for high temperature applications, which may be less flexible because the TPA device 200 does not use a hinge design.

During assembly, the terminal 102 is loaded into the terminal cavity 140. For example, the terminal 102 may be rear loaded into the terminal cavity 140 to position the mating end 110 of the terminal 102 at the front 130 of the housing 120. The socket 116 is aligned with the mating opening 142 to receive the mating terminal. In an exemplary embodiment, the front wall 144 is used to position the terminal 102 in the terminal cavity 140. For example, when the terminal 102 is fully loaded into the terminal cavity 140, the front of the terminal 102 is seated against the interior surface of the front wall 144. In the fully loaded position, the positioning element 118 of the terminal 102 is located forward of the access window 170. As such, the TPA device 200 is clear to pass through the access window 170 to a position immediately rearward of the positioning element 118. For example, the interference element 240 of the TPA device 200 is configured to be positioned in the terminal cavity 140 rearward of the positioning element 118 to block pullout of the terminal 102 from the terminal cavity 140 in a rearward direction. The interference element 240 is used to lock the terminal 102 in the terminal cavity 140 when the TPA device 200 is moved to the closed position.

During assembly, after the terminal 102 is loaded into the terminal cavity 140 the TPA device 200 may be actuated and moved to the closed position. For example, the operator may press inward (for example, downward) on the main panel 210 of the TPA device 200. With sufficient pressure is applied, the sacrificial connecting tabs 250 break at the neck portions 262 allowing downward movement of the TPA device 200. The front wall 220 is moved downward into the device channel 150. The front latch 224 is configured to interface with the front latching element 160 of the housing 120. The rear wall 230 is moved downward into the device channel 150. The rear latch 234 is configured to interface with the rear latching element 162 of the housing 120. The rear wall 230 passes through the access opening 170 into the interior of the terminal cavity 140. The rear wall 230 is configured to be positioned rearward of the positioning element 118 of the terminal 102 in a blocking or locking position. In an exemplary embodiment, the locating tab 158 is used to locate or guide movement of the TPA device 200 from the open position to the closed position. For example, the locating tab 158 is received in the locating opening 219 to control side to side and/or front to rear positioning of the TPA device 200 relative to the housing 120.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical connector comprising:
a housing extending between a front and a rear, the housing having a terminal cavity between the front and the rear, the housing having an access window open to the terminal cavity, the housing having device walls forming a device channel aligned with the access window;
a terminal received in the terminal cavity, the terminal including a mating end configured to be mated with a mating terminal, the terminal having a terminating end configured to be terminated to a cable, the terminal including a positioning element;
a terminal position assurance (TPA) device received in the device channel, the TPA device configured to move between an open position and a closed position, the TPA device including an interference element configured to interface with the positioning element of the terminal in the closed position to assure proper positioning of the terminal in the terminal channel, the TPA device including sacrificial connecting tabs holding the TPA device at the open position, wherein the sacrificial connecting tabs are configured to be separated to release the TPA device and allow movement of the TPA device from the open position to the closed position.

2. The electrical connector of claim 1, wherein the sacrificial connecting tabs are configured to be broken when pressure is applied to the TPA device to move the TPA device from the open position to the closed position.

3. The electrical connector of claim 1, wherein the TPA device is completely separated from the housing when the TPA device is moved from the open position to the closed position.

4. The electrical connector of claim 1, wherein the sacrificial connecting tabs, the TPA device, and the housing are integrated as a monolithic unitary structure.

5. The electrical connector of claim 1, wherein the sacrificial connecting tabs, the TPA device, and the housing are manufactured from a common plastic material.

6. The electrical connector of claim 1, wherein the housing includes a molded housing body manufactured from a plastic material, the TPA device included a molded device body manufactured from the plastic material of the housing, the sacrificial connecting tabs including molded sacrificial bodies being manufactured from a plastic material of the housing, wherein the molded housing body, the molded device body, and the molded sacrificial bodies are a monolithic unitary structure prior to breaking of the sacrificial connecting tabs.

7. The electrical connector of claim 1, wherein the housing includes a latching element, the TPA device including a latch, the latch being separated from the latching element in the open position, the latch engaging the latching element in the closed position.

8. The electrical connector of claim 1, wherein the interference element is aligned with the access window, the interference element configured to move through the access window into the terminal cavity to interface with the positioning element of the terminal as the TPA device is moved from the open position to the closed position.

9. The electrical connector of claim 1, wherein the interference element blocks pullout of the terminal from the terminal cavity in the closed position.

10. The electrical connector of claim 1, wherein the TPA device includes a main panel, a front wall extending from a front of the main panel, and a rear wall extending from a rear of the main panel, the front wall including a front latch, the rear wall including a rear latch, the front and rear latches engaging front and rear latching elements of the housing in the closed position, the sacrificial connecting tabs including front sacrificial connecting tabs extending from the front wall and rear sacrificial connecting tabs extending from the rear wall.

11. The electrical connector of claim 1, wherein the device channel is at a top of the housing, the TPA device moved downward into the device channel from the open position to the closed position.

12. The electrical connector of claim 1, wherein the housing includes a locating tab, the TPA device including a locating opening aligned with the locating tab, the locating opening receiving the locating tab in the closed position to locate the TPA device relative to the housing.

13. The electrical connector of claim 1, wherein the sacrificial connecting tabs and the TPA device are co-molded with the housing during a single molding process.

14. The electrical connector of claim 1, wherein the sacrificial connecting tabs are breakaway tabs configured to break when sufficient pressure is applied to the TPA device to move the TPA device from the open position to the closed position.

15. The electrical connector of claim 1, wherein the interference element is a locking element configured to lock the terminal in the terminal cavity when in the closed position.

16. The electrical connector of claim 1, wherein the TPA device extends between a front and a rear, the sacrificial connecting tabs including front sacrificial connecting tabs and rear sacrificial connecting tabs, the front sacrificial connecting tabs extending between the front of the TPA device and the device walls of the housing, the rear sacrificial connecting tabs extending between the rear of the TPA device and the device walls of the housing.

17. The electrical connector of claim 1, wherein the TPA device is integral and fixed to the housing in the open position, and wherein the TPA device is separated from the housing in the closed position.

18. An electrical connector comprising:
a housing extending between a front and a rear, the housing having a terminal cavity between the front and the rear, the housing having an access window open to the terminal cavity, the housing having device walls forming a device channel aligned with the access window, the housing including a front latching element in the device channel and a rear latching element in the device channel;
a terminal received in the terminal cavity, the terminal including a mating end configured to be mated with a mating terminal, the terminal having a terminating end configured to be terminated to a cable, the terminal including a positioning element;
a terminal position assurance (TPA) device received in the device channel, the TPA device configured to move between an open position and a closed position, the TPA device including a main panel, a front wall extending from a front of the main panel, and a rear wall extending from a rear of the main panel, the front wall including a front latch, the rear wall including a rear latch, the TPA device including an interference element configured to interface with the positioning element of the terminal in the closed position to assure proper positioning of the terminal in the terminal channel, the TPA device including front sacrificial connecting tabs extending from the front wall, the TPA device including rear sacrificial connecting tabs extending from the rear wall, the front and rear sacrificial connecting tabs configured to connect to the device walls of the housing hold the TPA device at the open position, wherein the front and rear sacrificial connecting tabs are configured to be separated from the device walls to release the TPA device and allow movement of the TPA device from the open position to the closed position.

19. The electrical connector of claim 18, wherein the housing includes a molded housing body manufactured from a plastic material, the TPA device included a molded device body manufactured from the plastic material of the housing, the sacrificial connecting tabs including molded sacrificial bodies being manufactured from a plastic material of the housing, wherein the molded housing body, the molded device body, and the molded sacrificial bodies are a monolithic unitary structure prior to breaking of the sacrificial connecting tabs.

20. An electrical connector comprising:
a housing extending between a front and a rear, the housing including a molded housing body being manufactured from a plastic material, the housing having a terminal cavity between the front and the rear, the housing having an access window open to the terminal cavity, the housing having device walls forming a device channel aligned with the access window;
a terminal received in the terminal cavity, the terminal including a mating end configured to be mated with a mating terminal, the terminal having a terminating end configured to be terminated to a cable, the terminal including a positioning element;
a terminal position assurance (TPA) device including a molded device body manufactured from the plastic material of the housing, the TPA device received in the device channel, the TPA device configured to move between an open position and a closed position, the TPA device including an interference element configured to interface with the positioning element of the terminal in the closed position to assure proper positioning of the terminal in the terminal channel, the TPA device including sacrificial connecting tabs holding the TPA device at the open position, the sacrificial connecting tabs including molded sacrificial bodies being manufactured from the plastic material of the housing, wherein the sacrificial connecting tabs are configured to be separated to release the TPA device and allow movement of the TPA device from the open position to the closed position;
wherein the molded housing body, the molded device body, and the molded sacrificial bodies are a monolithic unitary structure prior to breaking of the sacrificial connecting tabs.
